(19) United States
(12) Patent Application Publication
(10) Pub. No.: US 2025/0340171 A1
(43) Pub. Date: Nov. 6, 2025

(54) VEHICLE WITH BACKUP CAMERA VIEW FACILITY

(71) Applicant: Bulletproof Property Management, LLC, Cheyenne, WY (US)

(72) Inventor: Bennet Langlotz, Dallas, TX (US)

(73) Assignee: Bulletproof Property Management, LLC, Cheyenne, WY (US)

(21) Appl. No.: 19/194,920

(22) Filed: Apr. 30, 2025

Related U.S. Application Data
(60) Provisional application No. 63/642,561, filed on May 3, 2024.

(51) Int. Cl. B60R 1/28; G06V 20/58; H04N 7/18

(52) U.S. Cl. CPC B60R 1/28; G06V 20/586; H04N 7/185; B60R 2300/302; B60R 2300/8066

(57) ABSTRACT

A vehicle with backup camera view facility has a body having a front and rear end, a rear camera connected to the rear end of the body, and operable to generate an image of a objects to the rear of and lateral to the rear of the vehicle, the rear camera having a selected first angle of view, a controller connected the rear camera, a display connected to the controller, and the controller operable make a display angle selection to control the display to selectably display the first angle of view in a first selected circumstance, and to control the display to selectably display a second angle of view narrower than the first angle of view in a second selected circumstance. The display angle selection may be based on the presence of adjacent parked vehicles.

### CROSS-REFERENCE TO RELATED APPLICATION

This application claims the benefit of U.S. Provisional Patent Application No. 63/642,561 filed on May 3, 2024, entitled “VEHICLE BACKUP CAMERA VIEW FACILITY,” which is hereby incorporated by reference in its entirety for all that is taught and disclosed therein.

### FIELD OF THE INVENTION

This invention relates to motor vehicles, and more particularly to vision systems for vehicles.

### BACKGROUND AND SUMMARY OF THE INVENTION

Vehicles have wide angle back up cameras that are located at the center rear of the vehicle, and which typically provide a wide view of the area behind the vehicle to enable the driver to see that it is safe and clear before backing up.

These are normally very wide angle or fisheye views to see as much of the backup area immediately behind the vehicle as possible, even at the edges of the vehicle path. These may be provided by fisheye lenses having an angle of view of 180 degrees or more. Fisheye lenses have pronounced spherical distortion, especially at the edges. Such wide views, when displayed, produce images in which any visualized object or element (such as a child 10 feet away in the vehicle path) subtends a small angle, and is displayed at a very reduced scale. This small display can make identification and visual detection of objects difficult.

Some vehicle systems may have very wide lenses, but crop and enlarge to provide a larger scale view determined to be suitable for detection of obstacles in the path. This crops out the most distorted peripheral portions that are well outside of the vehicle reversing path, providing the benefit of an image with less apparent distortion, and larger scale images of any obstacles in the potential path.

Therefore, a need exists for a new and improved vehicle with backup camera view facility that can selectively display the full wide angle view, a cropped and enlarged view, or a processed version of the full wide angle view that reduces distortion to add useful edge segments to an otherwise cropped and enlarged view. In this regard, the various embodiments of the present invention substantially fulfill at least some of these needs. In this respect, the vehicle with backup camera view facility according to the present invention substantially departs from the conventional concepts and designs of the prior art, and in doing so provides an apparatus primarily developed for the purpose of selectively displaying the full wide angle view, a cropped and enlarged view, or a processed version of the full wide angle view that reduces distortion to add useful edge segments to an otherwise cropped and enlarged view.

The present invention provides an improved vehicle with backup camera view facility, and overcomes the above-mentioned disadvantages and drawbacks of the prior art. As such, the general purpose of the present invention, which will be described subsequently in greater detail, is to provide an improved vehicle with backup camera view facility that has all the advantages of the prior art mentioned above.

To attain this, the preferred embodiment of the present invention essentially comprises a motor vehicle having a body having a front and rear end, a rear camera connected to the rear end of the body, and operable to generate an image of a objects to the rear of and lateral to the rear of the vehicle, the rear camera having a selected first angle of view, a controller connected the rear camera, a display connected to the controller, and the controller operable make a display angle selection to control the display to selectably display the first angle of view in a first selected circumstance, and to control the display to selectably display a second angle of view narrower than the first angle of view in a second selected circumstance. The display angle selection may be based on the presence of adjacent parked vehicles. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a schematic view of the current embodiment of a vehicle with backup camera view facility constructed in accordance with the principles of the present invention installed in a vehicle.

FIG. 2 is a prior art display showing a typical scene cropped from a fisheye camera lens.

FIG. 3 is the prior art display of FIG. 2 showing a full uncropped view from the fisheye camera lens.

The same reference numerals refer to the same parts throughout the various figures.

### DESCRIPTION OF THE CURRENT EMBODIMENT

An embodiment of the vehicle with backup camera view facility of the present invention is shown and generally designated by the reference numeral 10.

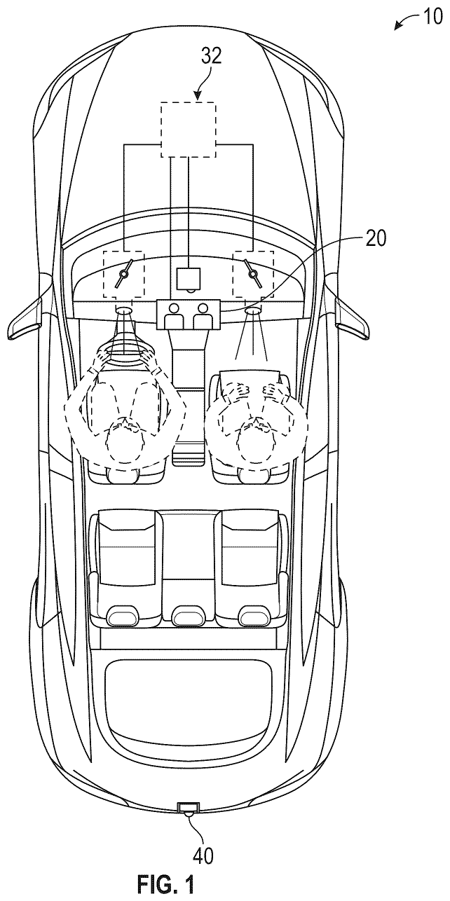

FIG. 1 illustrates the improved vehicle with backup camera view facility 10 of the present invention. More particularly, as shown schematically in FIG. 1, the vehicle with backup camera view facility 10 is equipped with a prior art interior display screen/display 20 connected to a controller/processor 32. A rear/backup camera 40 mounted centrally at the rear of the vehicle, typically above the license plate, is connected to the processor so the processor may display the captured scene for the driver.

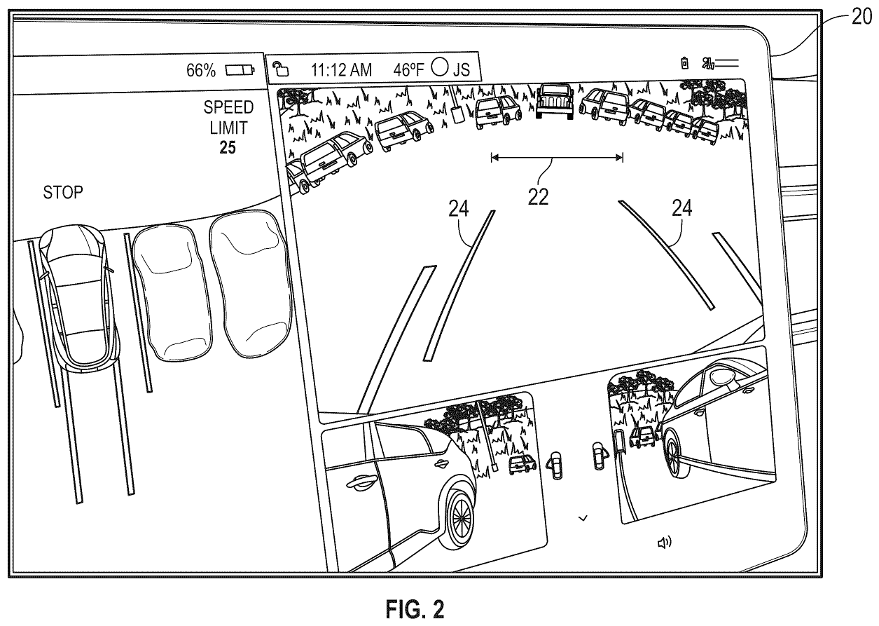

FIG. 2 shows the prior art interior display screen 20 showing a typical scene cropped from a fisheye camera lens. The scene is from a car parked in a parking lot having an aisle 22 with perpendicular parking spaces along each side. While the display shows a wide-angle view, the angle is much less than 180 degrees, apparently about 90-120 degrees. In this view, one sees the predicted vehicle path indicated by overlaid stripes 24, and the view offers an adequate view of the path at a suitable scale. While useful for backup safety to prevent running over obstacles, this angle of view is not ideal for other uses, such as detecting vehicles approaching perpendicularly down the aisle from some distance away.

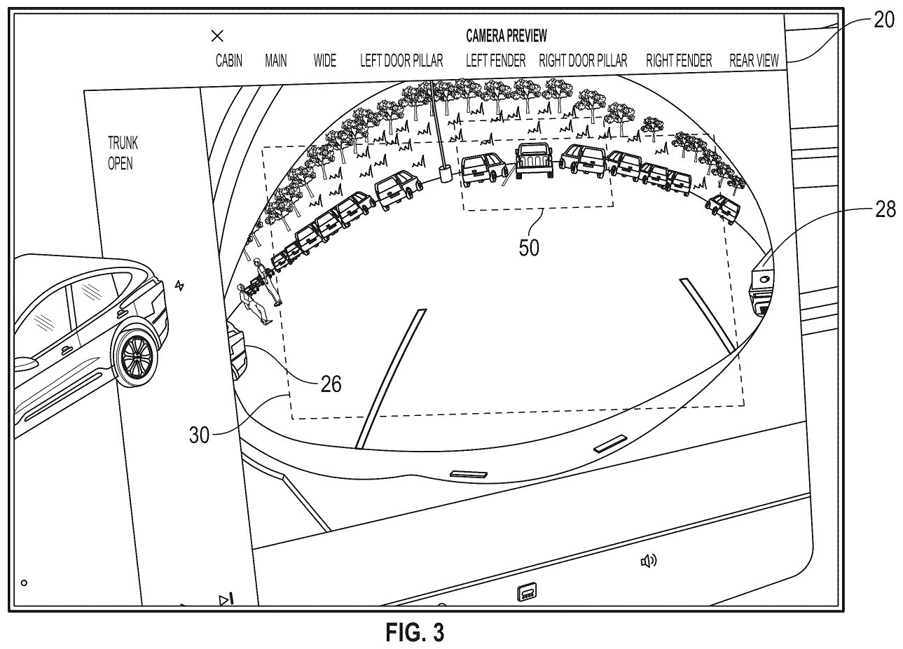

FIG. 3 shows the prior art interior display screen 20 with a full uncropped view of the camera image. This appears to be about 180 degrees, as it appears to show the rear bumpers 26, 28 of adjacent parked vehicles. Importantly, the view shows the ends of the parking lot aisle where other cars may be coming from, even at a distance. At left, pedestrians 26 not visible in the original cropped view are shown, and there is a clearly confirmed absence of vehicles approaching from either direction on the aisle. This indicates that it is safe to back out of the parking spot, once the pedestrians are safely clear.

The FIG. 2 crop frame is indicated by rectangle 30 in FIG. 3, showing the extra widest angle image area is included. This wide image might be displayed at all times, except for the scale disadvantages noted above. Therefore, it is desirable to selectably display the full-wide aisle view for cross traffic detection. The choice to display this can be based on a user manual input by a key input or by voice command. It may automatically be displayed when the vehicle detects a situation requiring a wide-angle view based on the surroundings of the vehicle. Such circumstances triggering a full wide angle display include this specific parking lot scenario: by being parked next to adjacent vehicles as detected by the rear camera or other side cameras on the car, or by detecting a perpendicular or other angled traffic lane with potential traffic approaching from either perpendicular or angled direction, or by detecting a row of parked cars or parking spaces opposite, or by stored map data indicating a parking lot aisle or street with potential cross traffic, or by data collected by the vehicle upon entering the parking spot now being exited and used to generate a map, or otherwise detecting or inferring a roadway or aisle that may have cross traffic behind the parked vehicle.

The wide display may be the full fisheye view as shown in FIG. 3, or the system may process that image, and redisplay the useful edge segments with processing to reduce distortion and create a “down the aisle” view on each edge of the original image as a triptych. This may be useful because not all of the periphery of the wide view are needed. Only the segments at the edge just above and below the horizon or driving surface by a limited elevation (as opposed to the upper corners showing the sky and lower corners showing the vehicle's own bumper).

The system may also optionally display the standard cropped view for the driver to see when the system is in a self-driving mode without driver input, and employ the full wide-angle view or the processed “down the aisle” view for the self-driving system's use without displaying the full wide-angle view or the processed “down the aisle” view for cross traffic detection down the aisles.

The benefits of cropping a wide rear image may also include more than backup safety in parking lots. For instance, the rear camera's image may be used in lieu of a rear-view mirror and displayed on the screen. However, for a view of vehicles traveling in the lane behind, even the cropped wide angle backup view is excessively wide, which creates a distorted sense of distance to vehicles behind. A vehicle at a safe highway following distance may appear too distant to see or identify. Therefore, the system may additionally crop the image to the distant “Rear view mirror” view indicated by frame 50. This view may be magnified to a standard angle of view of about 20-30 degrees wide. This may be the view normally displayed when travelling forward or above certain speeds, and as shown the view may be cropped from an upper portion of the rear camera that is typically aimed downward below the horizontal to capture the surface behind. This view may also be displayed on an auxiliary display at, near, or over the normal interior rear-view mirror, which can be useful when the view to the rear is blocked by passengers, cargo, a rear wing, or a bed cover. A high-resolution camera may be advantageous for enlarging this segment usefully, or a separate camera may be used.

In the preferred embodiment, the wide-angle view is normally about 180 degrees, with wider views being acceptable but rarely necessary for a straight roadway or vehicle path behind and transverse to the vehicle. Views at least 170 degrees are preferred to avoid missing more than limited distant objects, and at least 160 to gain some but not all benefits of a wide view. These are typically fisheye views with commonly associated distortion or projection, as opposed to rectilinear lenses. The controller may process the image to reduce or eliminate distortion, including cropping away unimportant areas that are not pertinent to vehicle operation, safety, and potential obstacles, and enhancing the visibility of pertinent and important areas.

The narrower cropped standard view for normal reversing when resolution and detection are preferred, and not the special circumstance where distant or nearer objects are needed to be seen in either lateral direction, preferably has a view of at least 90 degrees when resolution is a higher priority than normal field of view, and at least about 100 degrees in normal circumstances with a typical balance of resolution and field of view, and 120 degrees when a wide field is desired and resolution is adequate. The angle of view for rear view mirror functions while driving forward are much less: Preferably less than 60 degrees, often less than 30, and for highway travel potentially less than 25 or 20. The ratio of the standard view to the wide-angle view is normally at least 0.5, and typically at least 0.67. A ratio of 0.75 may provide limited benefits. For normal rear-view mirror functions when traveling forward, the ratio may be less than 0.33 for some needs, less than 0.25 for more typical needs, and less than 0.167 for highway driving and other needs.

It should be appreciated that the vehicle with backup camera view facility includes a motor vehicle 10 having a body having a front and rear end, a rear camera 40 connected to the rear end of the body, and operable to generate an image of a objects to the rear of and lateral to the rear of the vehicle, the rear camera having a selected first angle of view, a controller 32 connected the rear camera, and a display 20 connected to the controller. The controller is operable make a display angle selection to control the display to selectably display the first angle of view in a first selected circumstance, and to control the display to selectably display a second angle of view narrower than the first angle of view in a second selected circumstance. The display angle selection can be based on a variety of factors including the presence of adjacent parked vehicles, detecting a traffic configuration to the rear that has the possibility of cross traffic, detecting a row of parking locations opposite the motor vehicle to the rear, map data, data gathered by the motor vehicle during prior operation to the current location, and a vehicle path behind and transverse to the motor vehicle. The first angle of view can be at least 160 degrees or at least 180 degrees. The second angle of view can be at most 120 degrees or at most 100 degrees. A ratio of the second angle of view to the first angle of view can be at most 0.75 or at most 0.67. The controller is operable to make a display angle selection to control the display to selectably display a third angle of view narrower than the second angle of view in a third selected circumstance. The third selected circumstance can be when the vehicle is driving forward.

While a current embodiment of a vehicle with backup camera view facility has been described in detail, it should be apparent that modifications and variations thereto are possible, all of which fall within the true spirit and scope of the invention. For example, while discussed in terms of a rear camera for a backing out vehicle, all of the above principles may be applied to a vehicle with a front camera for heading forward out of a parking space where visibility of objects ahead may be limited by vehicle configuration, and visibility of approaching vehicles may be limited by adjacent parked vehicles. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A motor vehicle comprising:
a body having a front and rear end;
a rear camera connected to the rear end of the body, and operable to generate an image of a objects to the rear of and lateral to the rear of the vehicle;
the rear camera having a selected first angle of view;
a controller connected the rear camera;
a display connected to the controller; and
the controller operable make a display angle selection to control the display to selectably display the first angle of view in a first selected circumstance, and to control the display to selectably display a second angle of view narrower than the first angle of view in a second selected circumstance.

2. The motor vehicle of claim 1 wherein the display angle selection is based on the presence of adjacent parked vehicles.

3. The motor vehicle of claim 1 wherein the display angle selection is based on detecting a traffic configuration to the rear that has the possibility of cross traffic.

4. The motor vehicle of claim 1 wherein the display angle selection is based on detecting a row of parking locations opposite the motor vehicle to the rear.

5. The motor vehicle of claim 1 wherein the display angle selection is based on map data.

6. The motor vehicle of claim 1 wherein the display angle selection is based on data gathered by the motor vehicle during prior operation to the current location.

7. The motor vehicle of claim 1 wherein the display angle selection is based on a vehicle path behind and transverse to the motor vehicle.

8. The motor vehicle of claim 1 wherein the first angle of view is at least 160 degrees.

9. The motor vehicle of claim 1 wherein the first angle of view is at least 180 degrees.

10. The motor vehicle of claim 1 wherein the second angle of view is at most 120 degrees.

11. The motor vehicle of claim 1 wherein the second angle of view is at most 100 degrees.

12. The motor vehicle of claim 1 wherein a ratio of the second angle of view to the first angle of view is at most 0.75.

13. The motor vehicle of claim 1 wherein a ratio of the second angle of view to the first angle of view is at most 0.67.

14. The motor vehicle of claim 1 wherein the controller is operable to make a display angle selection to control the display to selectably display a third angle of view narrower than the second angle of view in a third selected circumstance.

15. The motor vehicle of claim 14 wherein the controller is operable make a display angle selection to control the display to selectably display a third angle of view when the vehicle is driving forward.
